(19) United States
(12) Patent Application Publication
(10) Pub. No.: US 2005/0098564 A1
(43) Pub. Date: May 12, 2005

(54) Packaging for paint comprising lid with integral roller tray

(75) Inventors: Jeroen Karel Verbrugge, Hoek van Holland (NL); Abke Geels, Den Hoorn (NL); Marc C. Van Zijl, Delft (NL)

Correspondence Address: OLIFF & BERRIDGE, PLC, P.O. BOX 19928, ALEXANDRIA, VA, 22320, US

(73) Assignee: AKZO NOBEL COATINGS INTERNATIONAL B.V., Arnhem (NL)

(21) Appl. No.: 10/506,969

(22) PCT Filed: Apr. 24, 2003
(86) PCT No.: PCT/NL03/00307

(30) Foreign Application Priority Data
Apr. 26, 2002 (NL) 1020493

(51) Int. Cl. B05C 21/00

(52) U.S. Cl. 220/570

(57) ABSTRACT

The packaging comprises a container for the substance, which an open top side and a plastic lid on the top side of the container. This plastic lid comprises a first covering part and a second covering part, the first covering part being provided with a substance-distributing profile on the underside. The first covering part can be pivoted open about a hinge located between the fist covering part and the second covering part, in such a manner that, to use the substance-distributing profile, the first covering part can be placed at an angle with respect to the second covering part, which remains connected to the container. The lid is formed integrally from plastic by means of injection moulding, the hinge between the first covering part and the second covering part being moulded as a integral component of the lid and also being leaktight with respect to the substance for which the packaging is intented.

The invention relates to a packaging for a substance which is applied to a base using a roller, such as paint. The packaging comprises a container for the substance, having an open top side and a plastic lid for closing off the open top side of the container. The lid comprises a first covering part and a second covering part, the first covering part being provided with a substance-distributing profile on the underside. The first covering part can be pivoted open about a hinge located between the first covering part and the second covering part, in such a manner that, to use the substance-distributing profile, the first covering part can be placed at an angle with respect to the second covering part, which remains connected to the container during use.

U.S. Pat. No. 6,102,235 describes a plastic lid which is intended to be used in combination with a container for paint, comprising a basic element and a flap which is pivotably connected to the basic element. The basic element is secured to the open top side of the container. When the flap is closed, it closes off the opening in the basic element and therefore, together with the basic element, forms a closed lid for the container. On the side of the flap which faces downwards when the packaging is closed, there is a paint-distributing profile. As a result of the flap being opened and then fixed at an acute angle with respect to the basic element by means of a support, a stable surface is formed which can be used to distribute the paint uniformly over a paint roller. The stock of paint in the container can be reached through the opening in the basic element which has been made accessible as a result of the flap being opened.

From a design viewpoint, the lid described in U.S. Pat. No. 6,102,235 has a number of drawbacks. For example, to produce a leaktight packaging, it is necessary to have two seals functioning correctly: one between the basic element and the container and one between the basic element and the flap.

In addition, to produce a leaktight packaging and to prevent the paint from drying out, in the known packaging it has been selected to position the hinge at a certain distance from the opening in the basic element. However, this means that special measures are required to prevent the paint from dripping off the inclined flap onto the outer side of the basic element. Therefore, with the lid described in U.S. Pat. No. 6,102,235, an additional surface can be added to the flap, extending beyond the hinge. However, this additional surface must be arranged in such a manner that it does not prevent the flap from rotating and thereby prevent the hinge from operating.

The object of the invention is to provide an inexpensive packaging which is of simple design and efficient to produce and which eliminates the abovementioned drawbacks.

The invention achieves this object by means of a packaging for a substance which is applied to a base using a roller according to claim 1.

Designing the lid as a single part by means of an integrally moulded hinge eliminates the assembly operations from the production process which are required in the known packaging. The logistics of the overall production process are also simplified, and only one injection mould, of limited size, is required to produce the lid.

Integrating the container and lid in a single part is considered undesirable on account of the loss of flexibility relating to the choice of shape and volume of the container and because integration of this type would lead to a large and expensive injection mould.

By directly and integrally moulding the hinge, which is preferably designed as an integral hinge made from the same material as the lid parts or which is made from another material if a two-component injection-moulding method is used, large local thickness changes in the lid are avoided. In addition, integrally moulding the hinge makes it possible, and even preferred, for the hinge to be positioned directly at the edge of the opening through which access is gained to the contents of the packaging. As a result, there is no need for an additional surface on the first covering part to prevent drips from passing from the pivoted-open first covering part onto the outer side of the lid.

The hinge is preferably of airtight design.

In the top edge of the container there is preferably a locally arranged projection which adjoins the lid in a sealing manner. As a result of a projection of this type being arranged at any location where the hinge is located with the lid fitted, the sealing of the packaging as a whole is optimized. The projection can also be used to position the lid with respect to the container.

It is preferable for the projecting protective rim which is known from U.S. Pat. No. 6,102,235 to be replaced by a protective rim which is U-shaped in cross section and the open side of which faces towards the first covering part. In this case, it is preferable for the first covering part to be interrupted over the width of the protective rim. These measures enable this detail to be produced more successfully by injection moulding, since there is no need for the flow of plastic to split.

This shaping of the protective rim also leads to the first covering part having a higher stiffness, which is important in particular when it is used together with the roller. This is because in this situation additional forces are exerted on the first covering part and these forces could lead to undesirable deformation of the first covering part. This is undesirable in terms of stability and ease of use.

One or more reinforcing ribs may be arranged in the second covering part. The primary purpose of these ribs is to increase the stiffness of the lid and therefore the packaging in the vicinity of the hinge. As a result, the packaging as a whole will in particular have a greater resistance to torsion compared to a packaging without this additional rim in the vicinity of the hinge. The second covering part preferably has a reinforcing rib which extends alongside the hinge over the width of the lid and is preferably formed on the underside of the covering part.

In one possible embodiment, some elasticity in the lateral direction is produced in the protective rim by suitable shaping of the protective rim of the first covering part. In this context, it is possible to dimension the protective rim in such a way that the elasticity can be used when the packaging is being closed. In this event, the protective rim is pressed slightly inwards by adjoining the side walls of the container, so that the protective rim, when the packaging is closed, bears against the top side of the inner periphery of the container under a certain prestress.

Given a U-shaped cross section of the protective rim, it is preferable for closure surfaces to be arranged at both ends of the protective rim, in the vicinity of the hinge, in the plane perpendicular to the surface of the lid.

As an alternative to the protective rim bearing against the inner periphery of the container—or if appropriate in combination with such a measure—the seal can be produced by an outer rim of the first covering part which, when the packaging is closed, bears against the outer side of the container.

The closing of the packaging is preferably configured in such a way that the packaging can be used in paint-mixing machines.

The substance-tight hinge preferably extends across the lid in the transverse direction, i.e. in such a manner that the hinge connects two points which lie in the plane of the lid, on opposite sides of the lid.

It is preferable for the substance-tight hinge to extend in the transverse direction across the entire lid. The result is a first covering part whose dimension in this transverse direction corresponds to that of the container. As a result, there is no need for a separate seal between the first and second covering part apart from the hinge.

The connection between the container and the lid is produced by coupling means. These coupling means are preferably designed in such a way that the connection between the second covering part and the container remains in place while the packaging is in use. If the cover is designed with a hinge which extends transversely across the entire lid, it is possible for the coupling means, at the location of the first covering part, to be provided with a seal which is to be broken when the packaging is first used.

The coupling means are preferably designed to form a click-fit connection between the lid and the container. The coupling means are preferably designed in such a way that the click-fit connection between the first covering part and the container can be released more easily than the click-fit connection between the second covering part and the container.

In practice, it has been found that in general containers which are substantially rectangular in shape are difficult to open. In the packaging according to the invention, there is provision for the coupling means, which form, for example, a click-fit connection, to be interrupted at the corners of the first covering part.

In one possible embodiment, there is a breakable connection between the first covering part and the second covering part at at least one end of the hinge element and substantially at right angles to the plane of the lid, as an integral component of the lid, which is broken when the packaging is opened for the first time.

It is preferable for the first covering part to be larger than the second covering part, for example for the dimension of the first covering part in the plane of the lid, perpendicular to the hinge, to be approximately three times as great as the dimension of the second covering part in the plane of the lid, perpendicular to the hinge.

The opening in the lid which is opened after the first covering part has been pivoted open is preferably sufficiently large for a standard roller for applying a substance to a base to be able to fit through it easily.

It is preferable for the substance-distributing profile to be arranged in such a manner that it is at least partially visible even when the packaging is closed. This is preferably achieved by the substance-distributing profile being formed by ribs which project downwards out of the surface of the lid and by recesses being formed in the lid at the top side of the lid at the location of the ribs. As a result, even in the closed state, the packaging can easily be distinguished from known packaging means without a substance-distributing surface.

When forming the lid it is preferable to enable the lid to be fitted to the container with the aid of a pick-and-place unit. This can be achieved, for example, by providing a planar part in the lid, on which a suction cup of a pick-and-place unit can engage.

In an advantageous embodiment, a projecting rim is formed on the top side of the lid, while in the base of the container there is preferably a space which is able to be receive this rim belonging to a similar container placed beneath it. This allows sturdy stacking of these packaging means. Designing the projecting rim as a locating rim which acts in combination with the space in the base of the container above it enables a packaging to adopt an optimum position during stacking with respect to the packaging on which the packaging in question is stacked.

In conventional paint-mixing machines, the packaging in which the paint is mixed is held between two plates which respectively engage on the top side and the underside of the packaging. The paint in the packaging is mixed as a result of a movement, for example vibration, being imparted to the plates. It is preferable for the projecting rim on the lid and the space in the base to be designed to be received on plates of this type.

After the packaging has been opened, it is preferable for the first covering part to be fixed in the pivoted-open position, in which the first covering part is at an angle, preferably an acute angle, with respect to the second covering part. In an advantageous embodiment, this is achieved by click-fitting the first covering part securely onto the projecting rim of the second covering part.

Exemplary embodiments of a packaging according to the invention will be explained in more detail below with reference to the appended drawing illustrating exemplary embodiments of the packaging according to the invention. In the drawing:

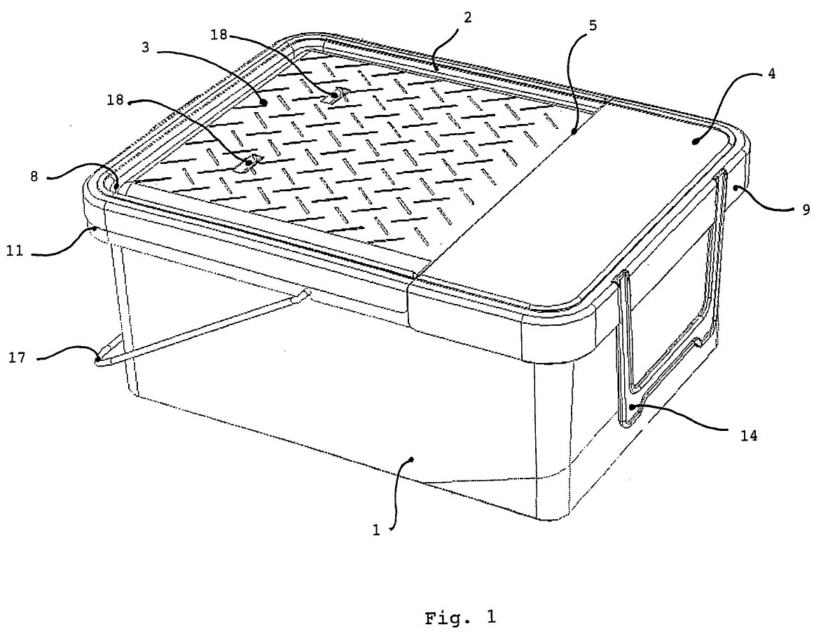

FIG. 1 shows an overview of a first embodiment of the packaging in a closed position,

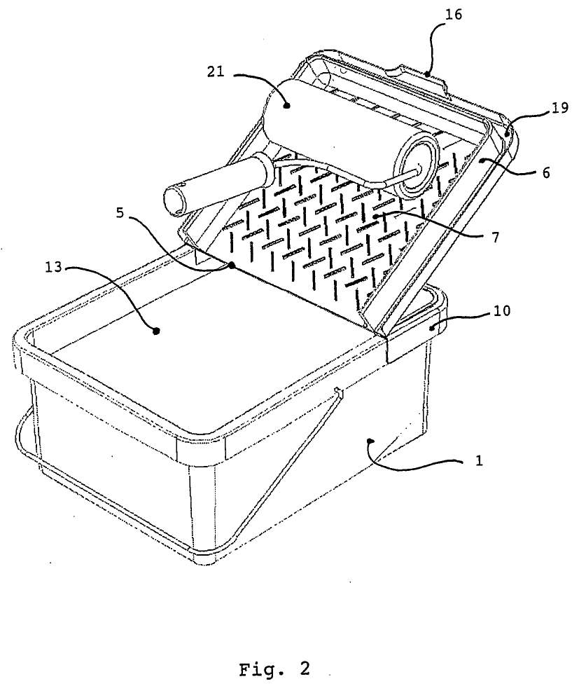

FIG. 2 shows an overview of the packaging shown in FIG. 1 in the open position,

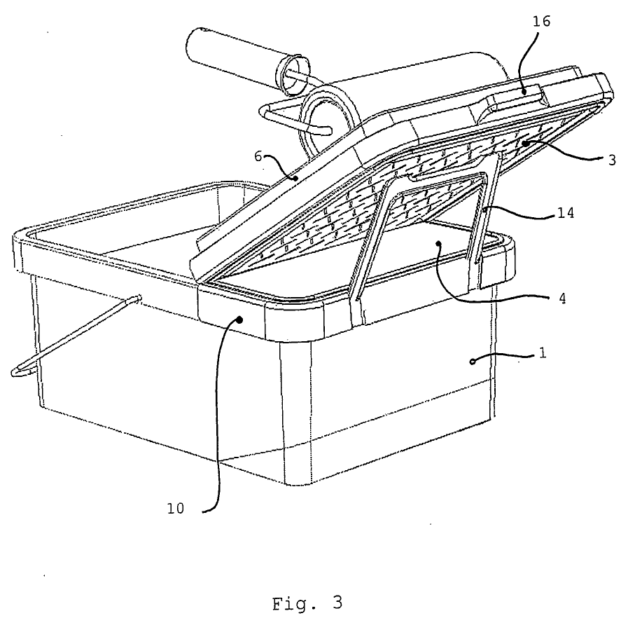

FIG. 3 shows an overview of the packaging shown in FIG. 1 in the open position, from a different angle,

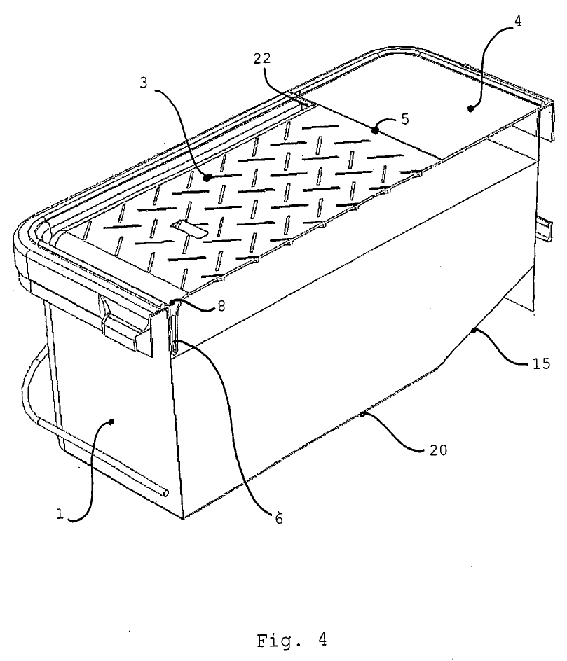

FIG. 4 shows the packaging illustrated in FIG. 1 in the closed position, in section,

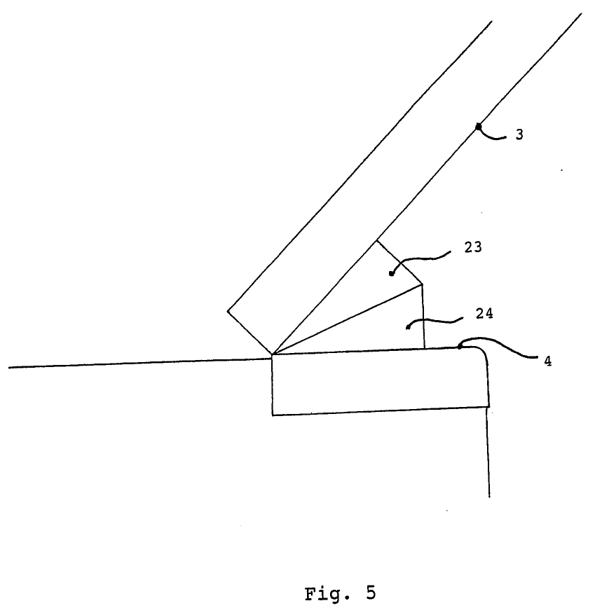

FIG. 5 shows an alternative embodiment,

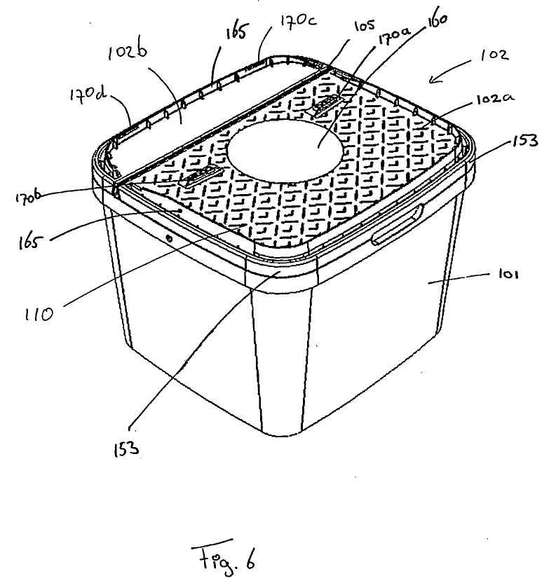

FIG. 6 shows a second alternative embodiment,

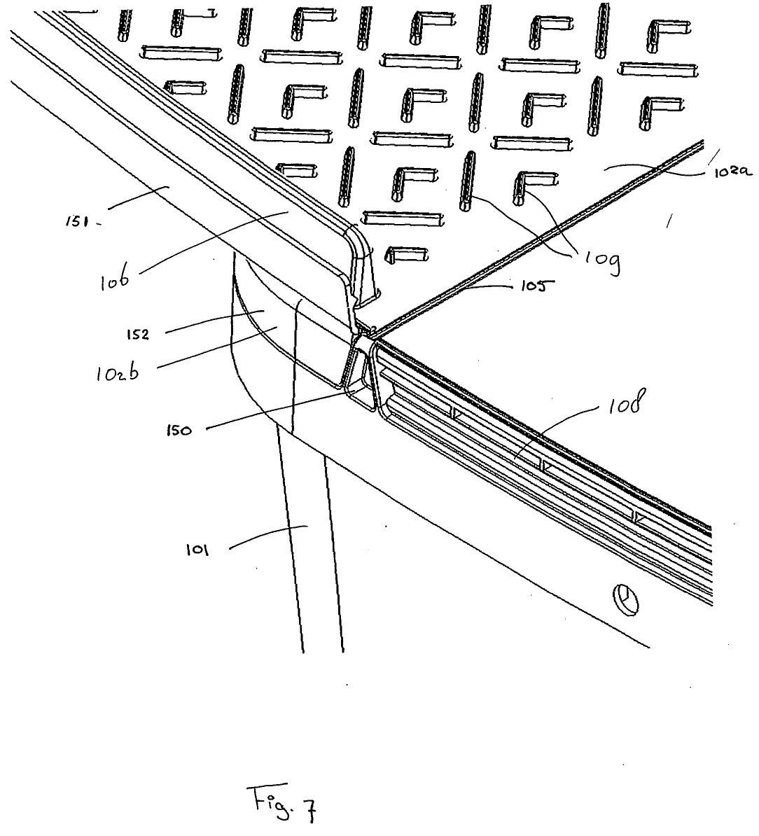

FIG. 7 shows a detail of the embodiment shown in FIG. 6,

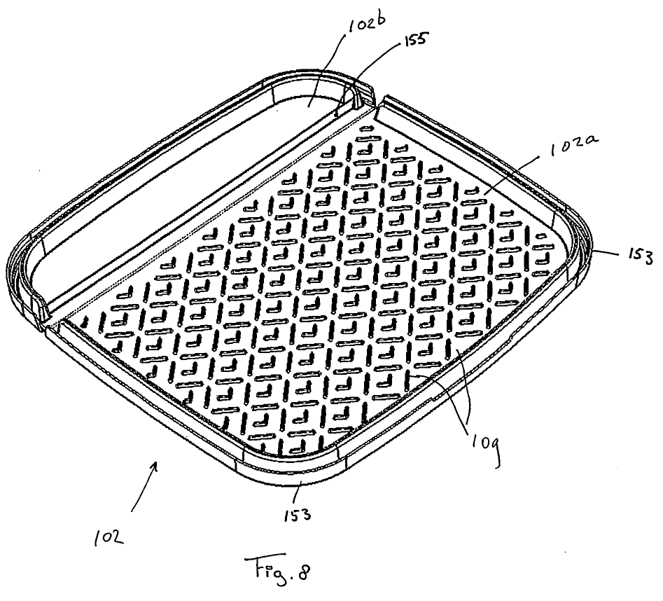

FIG. 8 shows a view of the lid used in the embodiment shown in FIG. 6 from below,

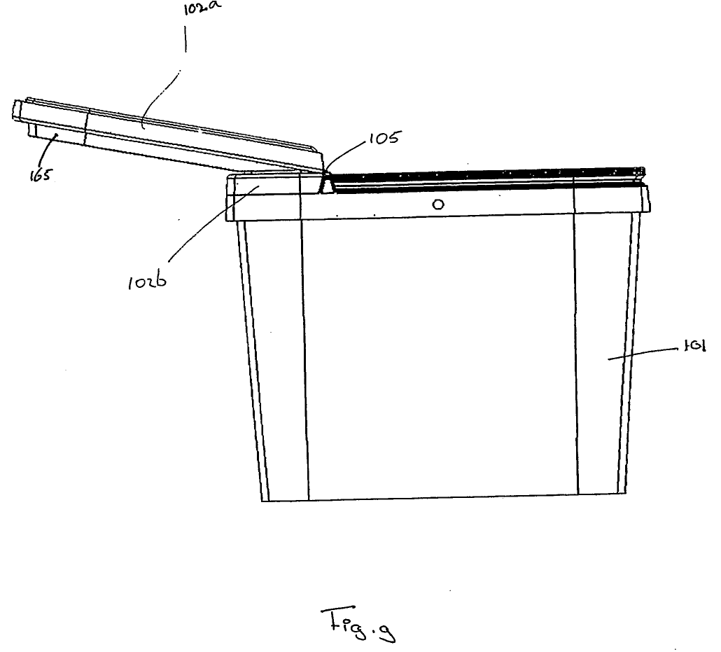

FIG. 9 shows a side view of the embodiment shown in FIG. 6, in the open position,

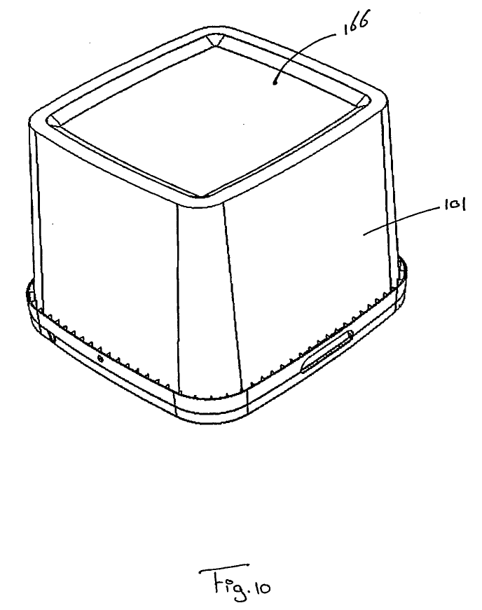

FIG. 10 shows a view of the container illustrated in the embodiment shown in FIG. 6 from below.

FIG. 1 shows an exemplary embodiment of the packaging according to the invention in the closed position. The substance, for example paint, is located in a container 1, which is open at the top side. The top side of the packaging is closed by a lid 2 made from plastic.

The lid 2 is divided into a first covering part 3 and a second covering part 4. There is a hinge 5 between first covering part 3 and second covering part 4. Coupling means 9 is responsible for the connection between lid 2 and container 1.

The lid 2 is designed as a single injection-moulded part in which all the components are integrated. As a result, the lid can be produced quickly, efficiently and at low cost. The integrally moulded hinge 5 may, for example, be designed as an integral hinge or as a two-component hinge.

A support 14 which can be pivoted open is integrated in the lid 2. The support 14 can face downwards when the packaging is closed, as shown in FIG. 1, or may rest flat in or on the lid 2. To allow simple handling of the packaging, there is a carrying element 17.

FIGS. 2 and 3 show the packaging in the open position, in which it is also possible to make use of the substance-distributing profile 7 for uniformly distributing the substance over a roller 21 which is used to apply the substance to a base. Therefore, it is no longer necessary to provide a separate roller tray for this application, and therefore it is also impossible to forget the tray.

To open the container 1 it is first of all necessary to remove seal 11 (cf. FIG. 1). By taking firm hold of handle 16 and lifting it up, a breakable connection 12 is torn open and the first covering part 3 can be folded open about hinge 5 until it forms an acute angle with the second covering part, which remains connected to the container 1 by locking rim 10. The position of the two covering parts with respect to one another is fixed by means of support 14. The support 14 is pivoted open from its starting position (cf. FIG. 1) until the surfaces provided for this purpose come into engagement with projections 18 in the first covering part 3 (cf. FIG. 3).

The contents of the container 1 are now readily accessible through opening 13, which is large enough for a standard paint roller to pass through. The first covering part 3 forms a stable surface which can be used to distribute the paint uniformly over the roller. The paint which remains behind on the substance-distributing surface 7 can run back into the container 1 via this surface without coming into contact with the outer surface of the packaging, with the result that the outer side of the packaging does not become smeared with paint.

A protective rim 6 ensures that no paint reaches closing surface 19 of the first covering part 3. In terms of injection-moulding technology, it is favourable for this protective rim 6 to be designed to be U-shaped in cross section, the open side of this U-shape facing towards the first covering part, while the first covering part is interrupted over the width of the protective rim. This is shown in FIG. 4.

As a result of the surface of the first covering part 3 being interrupted over the width of the protective rim 6, a groove 8 is formed, introducing elasticity into the protective rim 6 in the transverse direction.

Also, closure surfaces 22 are arranged at both ends of the protective rim in the vicinity of the hinge in the plane perpendicular to the surface of the lid. The protective rim 6 is arranged in such a manner that, when the packaging is being closed, the walls on the top side of the inner periphery of the packaging, at the location of the first covering part 3, cause the protective rim 6 to be deformed slightly inwards in the plane of lid 2. As a result, the protective rim comes to bear against the walls of the container 1 under a certain prestress, and it is impossible for any substance to move past the contact surface. In this way, protective rim 6 interacts with the top part of the inner periphery of container 1 in order to form a seal.

In the exemplary embodiment illustrated in FIGS. 1-4, that part of the base which is located beneath the second covering part is positioned obliquely with respect to the remainder of the base 20. This oblique base part 15 ensures that the last residues of paint collect beneath opening 13 of the packaging, so that the user does not have to reach under the second covering part using the roller 21.

After use, the container 1 can easily be closed again by pivoting the first covering part 3 back about hinge 5 and pressing the first covering part securely onto the container. In the process, protective rim 6 comes to bear against the top part of the inner periphery of container 1 under prestress and thereby produces a seal which ensures that the remaining contents of the container 1 do not dry out. Then, support 14 can also be folded back into its original position.

Since the substance-distributing surface is located on the inside after the container 1 has been closed again, the paint residue on the substance-distributing surface 7 will not dry out, with the result that this surface can be reused during a subsequent painting session to obtain a uniform distribution of paint over the roller 21 without residues of dried-out paint sticking to the roller. It is therefore not necessary to thoroughly clean the substance-distributing surface 7 after use.

In an embodiment which is not shown, the hinge is oriented obliquely with respect to the side walls of the container 1.

In an embodiment which is not shown, the packaging may be designed with a hinge which does not extend over the entire width or length of the lid. In this case, the first covering part is narrower than the container. The periphery of the second covering part is then the same length as the periphery of the container, and the second covering part is provided with an opening, which is preferably wide enough for a standard roller to pass through and over which the first covering part engages when the packaging is closed.

With this embodiment too, it is possible for the protective rim designed with the U-shaped cross section to function as a seal. In this case, the protective rim will not interact with the top part of the inner periphery of the container, but rather with a specially provided supporting rim on the second covering part. This supporting rim is arranged at the location of the protective rim, at the periphery of the opening in the second covering part, in such a manner that the supporting rim can interact with the protective rim of the first covering part.

FIG. 5 diagrammatically depicts an alternative embodiment, in which the support 14 which can be pivoted open has been replaced by rigid supporting elements 23 and 24. These supporting elements are integrated with the first covering part 3 and the second covering part 4, respectively. In a variant, there is only one supporting element.

FIGS. 6-10 show a second alternative embodiment of the packaging according to the invention. The container 101 is rectangular in shape, with side walls, a base and an open top side delimited by the top edge of the side walls. The open top side can be closed off using a lid 102 which has a first covering part 102a and a second covering part 102b, as well as a hinge 105 between the covering parts 102a, b. The covering parts 102a, b and the hinge 105 are formed from plastic as a single part using a suitable injection-moulding process.

In this embodiment, a projection 150 (FIG. 7) is arranged locally in the top edge of the container 101 and bears against the lid 102 in such a manner as to form a seal. This can be achieved, for example, by positioning the projection 150 at the location at which the hinge comes to lie when the lid 102 is fitted and by shaping the projection 150 in such a way as to be complementary to the shape of the hinge 105. This projection optimizes the sealing of the packaging as a whole. Projection 150 can also be used to position the lid 102 with respect to the container 101.

FIG. 8 shows the lid 102 from the underside. It is clearly apparent from FIG. 8 that an additional reinforcing rib 155, which lies alongside the hinge 105 and projects downwards, is arranged in the second covering part 102b. This rib 155 increases the stiffness of the packaging as a whole.

In the embodiment shown in FIGS. 6-9, the seal between the container 101 and the lid 102 is produced by means of the outer edges 151, 152 of the lid parts 102a, 102b which interact with the top edge 108 (FIG. 7) of the container 101. The outer edges 151, 152 are located at the outer periphery of the corresponding lid parts 102a, b. The outer edges 151, 152 and the associated parts of the top edge 108 form a click-fit connection, which facilitates positioning of the lid on the container. In this example, the edge 152 of covering part 102b clamps much more securely to the associated part of the top edge 108 of the container 101 than the click-fit edge 151. The result of this is that when the packaging is opened as a result of the first covering part 103 being pivoted open, the second covering part 104 remains connected to the container 101. Both click-fit connections are strong enough to ensure that the packaging remains closed when the packaging is used in a paint-mixing machine.

The outer edge 151 is interrupted and/or modified at the corners 153 of the lid 102, in such a manner that, firstly, the seal is still ensured but, on the other hand, the packaging can nevertheless be opened without difficulty.

In this case too, the first covering part 102a has a protective rim 106 which extends around the region with the substance-distributing profile, with the exception of the side on which the hinge 105 is located.

As can be seen from FIG. 6, the substance-distributing profile is also partially visible when the packaging is closed, on account of the top side of the lid 102 having the substance-distributing profile at the location of the first covering part 103. This is achieved by the substance-distributing profile being formed by ribs 109 which project downwards out of the surface of the lid and by recesses 110 being arranged in the lid at the top side of the lid at the location of the ribs. As a result, even in the closed state the packaging can easily be differentiated from packaging means which are already known.

A smooth surface 160 is arranged on the top side of the lid 102, in this case centrally in the region of the substance-distributing profile. A suction cup or the like of a pick-and-place unit can engage on this flat surface 160, which is advantageous for fitting the lid 102 to the container 101 during the production process.

In this case, a projecting rim 165, which is interrupted at the location of the hinge 105, is arranged on the lid 102, on the side remote from the container 101 when the packaging is closed, positioned slightly towards the inside with respect to the outer periphery.

In the base of the container 101 there is a recess 166 which can receive rim 165 (cf. FIGS. 9 and 10). In this way, it is possible for complete packages to be stacked robustly on top of one another. As a result of the projecting rim 165 being designed as a locating rim which acts in combination with the space 166 in the base of the container 101, it is possible to ensure that a packaging adopts an optimum position with respect to the packaging beneath it during stacking.

After the first covering part 103 has been pivoted open, the first covering part 103 is fixed in a position in which the first covering part 103 forms an acute angle with respect to the second covering part 104. For this purpose, in the lid 102 there are two securing members 170a, b which can fit securely onto the projecting rim 165 of the second covering part 102b. This projecting rim 165 is in this case provided with click-fit formations 170c, d, for example ribs, on which the said securing members 170a, b can engage.

1. Packaging for a substance which is applied to a base using a roller or the like, such as paint, which packaging comprises:
a container for the substance, with an open top side, and
a plastic lid on the top side of the container, which lid comprises:
a first covering part and a second covering part,
the first covering part being provided on the underside with a region with a substance-distributing profile, and
it being possible for the first covering part to be pivoted open about a hinge, which is located between the first covering part and the second covering part, in such a manner that, to use the substance-distributing profile, the first covering part can be positioned at an angle with respect to the second covering part, which remains connected to the container,
characterized in that the lid is formed integrally from plastic by injection moulding, the hinge between the first covering part and the second covering part being integrally moulded as part of the lid and also being leaktight with respect to the substance.

2. Packaging according to claim 1, characterized in that the hinge extends transversely over the entire lid.

3. Packaging according to claim 2, characterized in that the edge of the container comprises a projection at each location where the hinge ends at the edge of the container, which projection, in the closed position, adjoins the lid in such a mariner as to form a seal.

4. Packaging according to claim 1, characterized in that the first covering part has a protective rim, which protective rim is located on the underside of the first covering part and extends around the region with the substance-distributing profile, with the exception of the side on which the hinge is located.

5. Packaging according to claim 4, characterized in that the protective rim is substantially U-shaped in cross section, preferably substantially at right angles with respect to the plane of the lid, with the open side facing towards the first covering part, while the first covering part is interrupted over the width of the protective rim.

6. Packaging according to claim 4, characterized in that the protective rim is designed and arranged in such a manner that this protective rim interacts with parts of the side walls of the container which—in the closed position of the lid—bear against the outer side of the protective rim, in order to form a seal.

7. Packaging according to claim 1, characterized in that the first covering part is provided with a downwardly projecting outer rim which is designed and arranged in such a manner that this outside rim—in the closed position of the lid—bears against the outer side of parts of the side walls of the container in order to form a seal between container and lid.

8. Packaging according to claim 1, characterized in that in the lid there are ribs for increasing the stiffness of the packaging or parts of the packaging.

9. Packaging according to claim 1, in which the lid is provided with coupling means for producing a connection to the container, characterized in that the coupling means, at the location of the second covering part, is designed as an integral locking rim which, during use of the packaging, retains the connection between the second covering part and the container.

10. Packaging according to claim 1, in which the lid is provided with a coupling means for producing a connection to the container, characterized in that the coupling means, at the location of the first covering part, is designed for easily releasable coupling and is provided, for example, with a seal which can be broken prior to first use.

11. Packaging according to claim 9, characterized in that the coupling means are designed to form a click-fit connection to the container.

12. Packaging according to claim 1, in which the container and the lid are substantially rectangular in shape, characterized in that the coupling means are interrupted or modified in the vicinity of the corners of the lid on the side of the first covering part.

13. Packaging according to claim 1, characterized in that between the first covering part and the second covering part, at at least one end of the hinge and substantially perpendicular to the plane of the lid, as an integral component of the lid there is a breakable connection which is broken when the packaging is opened for the first time.

14. Packaging according to claim 1, characterized in that the dimension of the first covering part in the plane of the lid, perpendicular to the hinge, is approximately three times as great as the dimension of the second covering part in the plane of the lid, perpendicular to the hinge.

15. Packaging according to claim 1, characterized in that the opening in the container which is opened up after the first covering part has been pivoted open is sufficiently large for a standard roller for applying a substance to a base to be able to fit through it easily.

16. Packaging according to claim 1, characterized in that the lid has a projecting rim on the top side.

17. Packaging according to claim 16, characterized in that the projecting rim extends along the entire periphery of the lid and is interrupted at the location of the hinge.

18. Packaging according to claim 16, characterized in that the base of the container has a space for receiving the projecting rim.

19. Packaging according to claim 16, characterized in that the projecting rim is designed as a locating rim which acts in combination with the space in the base of the container.

20. Packaging according to claim 1, characterized in that the supporting of the first covering part at an angle with respect to the second covering part is realized by supporting elements which are integrated with the first covering part and the second covering part, respectively.

21. Packaging according to claim 20, characterized in that a projecting rim on the second covering part forms a supporting element.

22. Packaging according to claim 20, characterized in that the lid comprises at least one connecting member which is responsible for fixing the first covering part at an angle with respect to the second covering part.

23. Packaging according to claim 1, characterized in that the substance-distributing profile is formed by ribs which project downwards out of the plane of the lid, and in that recesses are preferably formed in the lid, on the top side of the lid, at the location of the ribs.

24. Lid which is intended to be placed on a container according to claim 1.
